(19) United States
(12) Patent Application Publication
(10) Pub. No.: US 2005/0015599 A1
(43) Pub. Date: Jan. 20, 2005

(54) Two-phase hash value matching technique in message protection systems

(75) Inventors: Bing Wang, San Jose, CA (US); James Card, Nashua, NH (US); Gregory J. Smith, Santa Clara, CA (US); Robert Paxton Scott, Sunnyvale, CA (US)

Correspondence Address: MERCHANT & GOULD PC, P.O. BOX 2903, MINNEAPOLIS, MN, 55402-0903, US

(73) Assignee: Nokia, Inc., Irving, TX (US)

(21) Appl. No.: 10/606,659

(22) Filed: Jun. 25, 2003

(51) Int. Cl. H04L 9/00

(52) U.S. Cl. 713/176

(57) ABSTRACT

The invention provides a two-phase hash value matching technique in message protection systems. This invention further improves the performance of message protection systems by avoiding computations associated with sophisticated signature hash value (SSHV) where possible. A message protection system that implements the two-phase hash value matching technique caches rough outline hash values (ROHVs) of previously scanned objects. The system can roughly distinguish one object from another using ROHVs. The system performs an initial check using ROHVs before performing the relatively time-consuming computations associated with SSHVs.

### FIELD OF THE INVENTION

The present invention relates to computer network security, and in particular to exploit protection for networks.

### BACKGROUND

The Internet connects millions of nodes located around the world, and has facilitated the exchange of information in the form of electronic messages known as email, web browsing, file transferring, instant messaging, and etc. With the click of a button, a user in one part of the world can access a file on another computer thousands of miles away. Due in part to the ease of transmitting information, there has been exploitation of the technology for unintended purposes. One of the first well-publicized cases of exploitation involved using emails to propagate a program. Once a computer became “infected” with the program, it would send email messages containing the program to other computers. Like a virus, the program spread from computer to computer with amazing speed. Now, the news reports virus-like programs (hereinafter “exploits”) on an almost daily basis. Some of these exploits are relatively benign; others destroy data or capture sensitive information. Unless properly protected against, these exploits can bring a company's network or computer systems to its knees or steal sensitive information, even if only a few computers are infected.

One of the most prevalent methods for dealing with these exploits is to deploy message protection systems at the Internet gateways, of which the core part is a scan engine, which inspects all messages passing through and detect such exploits. However, while many message protection systems can effectively detect the exploits in the messages, the throughputs of such systems are usually limited by bottlenecks of some necessary but time-consuming procedures. Building efficient message protection systems often eludes those skilled in the art.

### SUMMARY

Briefly stated, the present invention is directed at providing a system and method for protecting a device against an exploit using a two-phase hash value matching technique. The system receives an object that is directed to the device and, uses a two-phase hash value technique to determine whether the object has been previously scanned. If the object has been previously scanned, the system immediately processes the object without scanning the object again.

In one aspect, the invention is directed to a method for filtering out exploits passing through the device. The method receives an object that is directed to the device, determines a first value associated with the object and a second set of values associated with objects that have previously been scanned. If the first value matches at least one of the values in the second set, the method determines a third value associated with the object and a fourth set of values associated with the objects that have been previously scanned. If the third value matches at least one of the values in the fourth set, the method immediately processes the object.

In another aspect, the invention is directed to above method, in which the first value and the second set of values can only roughly distinguish one object from another, but can be computed from the associated objects efficiently. The third value and the fourth set of values, although require much more time to compute, can be used to identify one object from another confidently.

In yet another aspect, the invention is directed to a computer-readable medium encoded with a data-structure having a first indexing data field and a second data field. The first indexing data field has indexing entries where each indexing entry includes a first value. The second data field includes object-related entries where each object-related entry has a second value. Each object-related entry is indexed to an indexing entry in the first indexing data field and is uniquely associated with an object that has been previously scanned.

In yet another aspect, the invention is directed to a system for filtering out exploits. The system includes a message tracker and a scanner component. The message tracker is configured to determine whether an object had been previously scanned using a two-phase hash value technique. The scanner component is coupled to the message tracker and is configured to receive an unscanned object and to determine whether the unscanned object includes an exploit.

These and various other features as well as advantages, which characterize the present invention, will be apparent from a reading of the following detailed description and a review of the associated drawings.

### BRIEF DESCRIPTION OF THE DRAWINGS

FIGS. 1-3 show components of an exemplary environment in which the invention may be practiced;

FIG. 4 illustrates an exemplary environment in which a system for providing exploit protection for a network operates;

FIG. 5 illustrates components of a firewall operable to provide exploit protection;

FIG. 6 is a graphical representation of an exemplary process for inspecting an object using the object's SSHV;

FIG. 7 is a graphical representation of an exemplary process for inspecting an object using a two-phase hash value matching technique;

FIG. 8 is a graphical representation of a data structure that implements a two-phase hash value matching technique; and

FIG. 9 illustrates a flow chart for detecting exploits; according to embodiments of the invention.

### DETAILED DESCRIPTION

In the following detailed description of exemplary embodiments of the invention, reference is made to the accompanied drawings, which form a part hereof, and which are shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined by the appended claims.

In the following description, first definitions of some terms that are used throughout this document are given. Then, illustrative components of an illustrative operating environment in which the invention may be practiced is disclosed. Next, an illustrative operating environment in which the invention may be practiced is disclosed. Finally, a method of detecting and removing exploits is provided.

Definitions

The definitions in this section apply to this document, unless the context clearly indicates otherwise. The phrase “this document” means the specification, claims, and abstract of this application.

“Including” means including but not limited to. Thus, a list including A is not precluded from including B.

A “packet” refers to an arbitrary or selectable amount of data, which may be represented by a sequence of one or more bits. A packet may correspond to a data unit found in any layer of the Open Systems Interconnect (OSI) model, such as a segment, message, packet, datagram, frame, symbol stream, or stream, a combination of data units found in the OSI model, or a non OSI data unit.

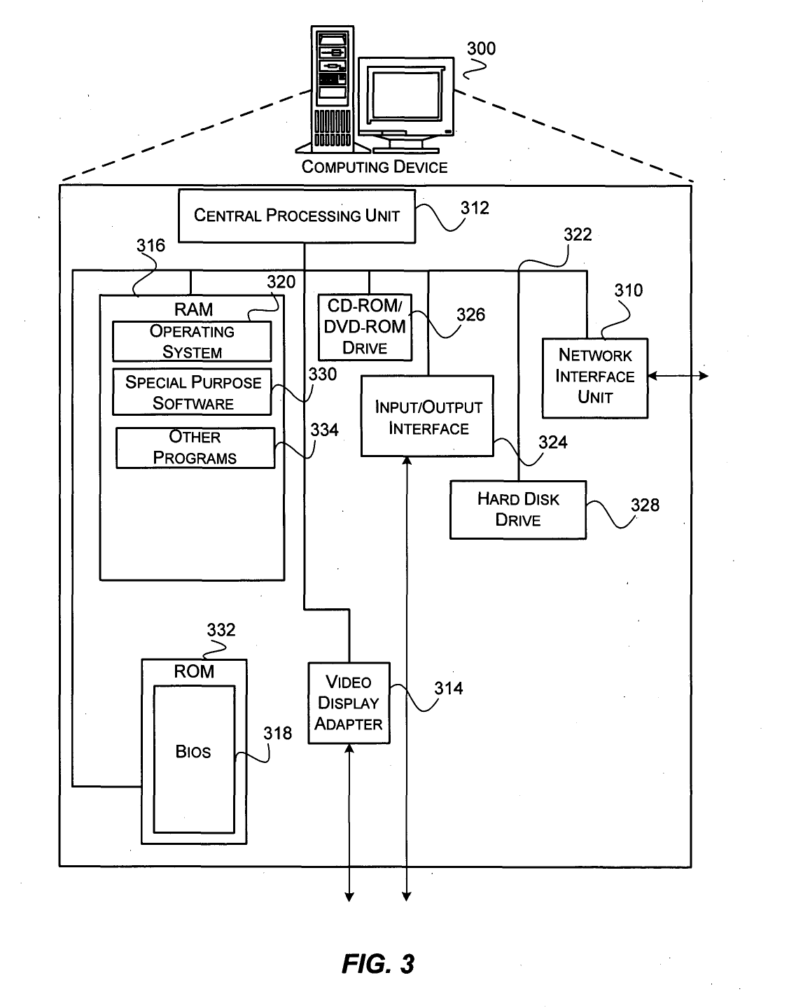

“Client” refers to a process or set of processes that execute on one or more electronic devices, such as computing device 300 of FIG. 3. A client is not constrained to run on a workstation; it may also run on a server such as a WWW server, file server, or other server, other computing device, or be distributed over a group of such devices. Where appropriate, the term “client” should be construed, in addition or in lieu of the definition above, to be a device or devices upon which one or more client processes execute, for example, a computing device, such as computing device 300, configured to function as a World Wide Web (WWW) server, a computing device configured as a router, gateway, workstation, etc.

Similarly, “server” refers to a process or set of processes that execute on one or more electronic devices, such as computing device 300 configured as a WWW server. Like a client, a server is not limited to running on a computing device that is configured to predominantly provide services to other computing devices. Rather, it may also execute on what would typically be considered a client computer, such as computing device 300 configured as a user's workstation, or be distributed among various electronic devices, wherein each device might include one or more processes that together constitute a server application. Where appropriate, the term “server” should be construed, in addition or in lieu of the definition above, to be a device or devices upon which one or more server processes execute, for example, a computing device configured to operate as a WWW server, router, gateway, workstation, etc.

An exploit is any procedure and/or software that may be used to improperly access a computer. Exploits include what are commonly known as computer viruses but may also include other methods for inappropriately gaining access to a computer. An exploit may be included in any object that is accessible by a computer, such as an email, a computer-executable file, a data file, and the like. The object may be transmitted to a computer through any type of communication methods, such as being attached to an email message. Referring to the drawings, like numbers indicate like parts throughout the figures and this document.

Definitions of terms are also found throughout this document. These definitions need not be introduced by using “means” or “refers” to language and may be introduced by example and/or function performed. Such definitions will also apply to this document, unless the context clearly indicates otherwise.

Deploying message protection systems at Internet gateways is used to protect against exploits. Each message protection system may include a scan daemon that inspects objects passing through the gateway, determines whether the objects contain exploits, and takes actions to deal with those objects with exploits. Many message protection systems configured in this manner can effectively protect against exploits. However, because such message protection systems indiscriminately and thoroughly check each object that passes through the gateway, the throughputs of such systems are significantly restricted.

The throughput of a message protect system depends on many parameters. One of the most significant parameters for throughput is the utilization of computational resources. To that end, bottlenecks are created when a message protection system has to perform significant amount of time-consuming though necessary processes, such as decompression engines, virus and content scan engines, and the like. Decompression engines are usually invoked to unpack archive objects, which can be compressed on multiple levels and be nested. Virus and content scan engines detect exploits in objects.

Reducing the need for those time-consuming processes mentioned above increases the throughput of a message protection system. One such method for improving system throughput is to cache hash values associated with known exploits and to check inspected objects against the hash values before passing the objects to the scan engine. If an object matches one of the cached hash values, the object will be directly determined to be malicious without being passed to the scan engine. Another method for improving system throughput is to cache hash values associated with recently and large clean objects. If the inspected object matches one of the cached hash values, the object will be directly determined to be clean without further computation.

While the two methods described above may be able to improve system throughput, the methods are generally implemented in such as way so as to ensure that one object can be distinguished from another object at a confident level. To achieve this, hash values are typically calculated based on a sophisticated signature hash function, such as Message Digest-5 (MD-5), Secure Hash Algorithm (SHA) and the like. A hash value computed from such a function is referred to as a sophisticated signature hash value (SSHV). Computations associated with obtaining SSHVs are relatively time-consuming, especially when the object is large. A message protection system that is capable of reducing computations associated with obtaining SSHVs can significantly increase system throughput.

Thus, the present invention is directed to a two-phase hash value matching technique in message protection systems. This invention further improves the performance of message protection systems by avoiding computations associated with SSHV where possible. In accordance with this invention, the message protection system caches rough outline hash values (ROHVs) of previously scanned objects. The system can roughly distinguish one object from another using ROHVs. The system performs an initial check using ROHVs before performing the relatively time-consuming computations associated with SSHVs. These and other aspects of the invention will become apparent after reading the following detailed description.

Illustrative Operating Environment

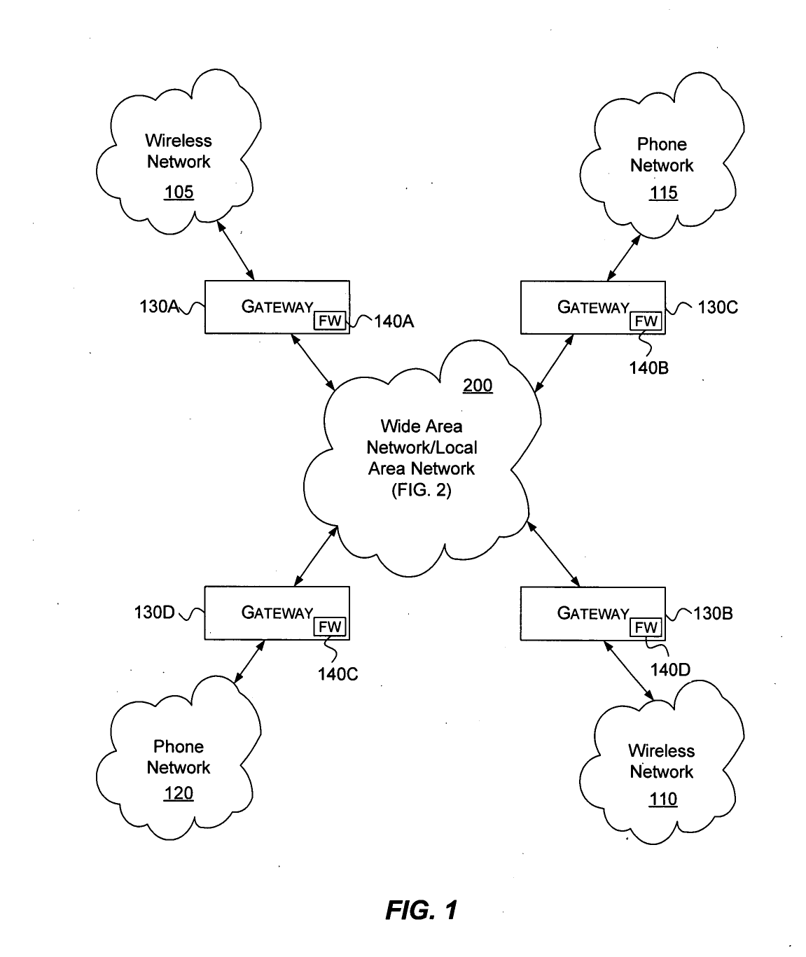

FIGS. 1-3 show components of an exemplary environment in which the invention may be practiced. Not all the components may be required to practice the invention, and variations in the arrangement and type of the components may be made without departing from the spirit or scope of the invention.

FIG. 1 shows wireless networks 105 and 110, telephone phone networks 115 and 120, interconnected through gateways 130A-130D, respectively, to wide area network/local area network 200. Gateways 130A-130D each optionally include a firewall component, such as firewalls 140A-140D, respectively. The letters FW in each of gateways 130A-130D stand for firewall.

Wireless networks 105 and 110 transports information and voice communications to and from devices capable of wireless communication, such as such as cell phones, smart phones, pagers, walkie talkies, radio frequency (RF) devices, infrared (IR) devices, CBs, integrated devices combining one or more of the preceding devices, and the like. Wireless networks 105 and 110 may also transport information to other devices that have interfaces to connect to wireless networks, such as a PDA, POCKET PC, wearable computer, personal computers, multiprocessor systems, microprocessor-based or programmable consumer electronics, network PCs, and other properly-equipped devices. Wireless networks 105 and 110 may include both wireless and wired components. For example, wireless network 110 may include a cellular tower (not shown) that is linked to a wired telephone network, such as telephone network 115. Typically, the cellular tower carries communication to and from cell phones, pagers, and other wireless devices, and the wired telephone network carries communication to regular phones, long-distance communication links, and the like.

Similarly phone networks 115 and 120 transport information and voice communications to and from devices capable of wired communications, such as regular phones and devices that include modems or some other interface to communicate with a phone network. A phone network, such as phone network 120, may also include both wireless and wired components. For example, a phone network may include microwave links, satellite links, radio links, and other wireless links to interconnect wired networks.

Gateways 130A-130D interconnect wireless networks 105 and 110 and telephone networks 115 and 120 to WAN/LAN 200. A gateway, such as gateway 130A, transmits data between networks, such as wireless network 105 and WAN/LAN 200. In transmitting data, the gateway may translate the data to a format appropriate for the receiving network. For example, a user using a wireless device may begin browsing the Internet by calling a certain number, tuning to a particular frequency, or selecting a browsing feature of the device. Upon receipt of information appropriately addressed or formatted, wireless network 105 may be configured to send data between the wireless device and gateway 130A. Gateway 130A may translate requests for web pages from the wireless device to hypertext transfer protocol (HTTP) messages which may then be sent to WAN/LAN 200. Gateway 130A may then translate responses to such messages into a form compatible with the wireless device. Gateway 130A may also transform other messages sent from wireless devices into message suitable for WAN/LAN 200, such as email, voice communication, contact databases, calendars, appointments, and other messages.

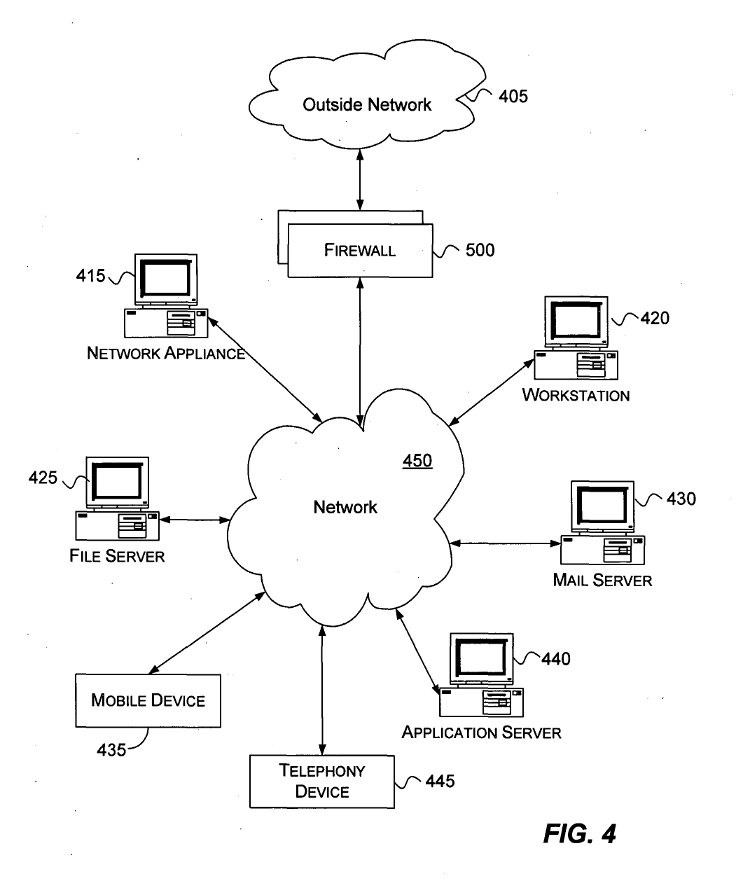

Before or after translating the data in either direction, the gateway may pass the data through a firewall, such as firewall 140A, for security, filtering, or other reasons. A firewall, such as firewall 140A, may include or send messages to an exploit detector. Firewalls and their operation in the context of embodiments of the invention are described in more detail in conjunction with FIGS. 4-6. Briefly, a gateway may pass data through a firewall to determine whether it should forward the data to a receiving network. The firewall may pass some data, such as email messages, through an exploit detector, which may detect and remove exploits from the data. If data contains an exploit, the firewall may stop the data from passing through the gateway.

In other embodiments of the invention, exploit detectors are located on components separate from gateways and/or firewalls. For example, in some embodiments of the invention, an exploit detector may be included within a router inside a wireless network, such as wireless network 105, that receives messages directed to and coming from the wireless network, such as wireless network 105. This may negate or make redundant an exploit detector on a gateway between networks, such as gateway 130A. Ideally, exploit detectors are placed at ingress locations to a network so that all devices within the network are protected from exploits. Exploit detectors may, however, be located at other locations within a network, integrated with other devices such as switches, hubs, servers, routers, traffic managers, etc., or separate from such devices.

In another embodiment of the invention, an exploit detector is accessible from a device that seeks to provide exploit protection, such as a gateway. Accessible, in this context, may mean that exploit protector is physically located on the server or computing device implementing the gateway or that the exploit detector is on another server or computing device accessible from the gateway. In this embodiment, a gateway, may access the exploit detector through an application programming interface (API). Ideally, a device seeking exploit protection directs all messages through an associated exploit detector so that exploit detector is “logically” between the networks that the device interconnects. In some instances, a device may not send all messages through an exploit detector. For example, an exploit detector may be disabled or certain messages may be explicitly or implicitly designated to avoid the exploit detector.

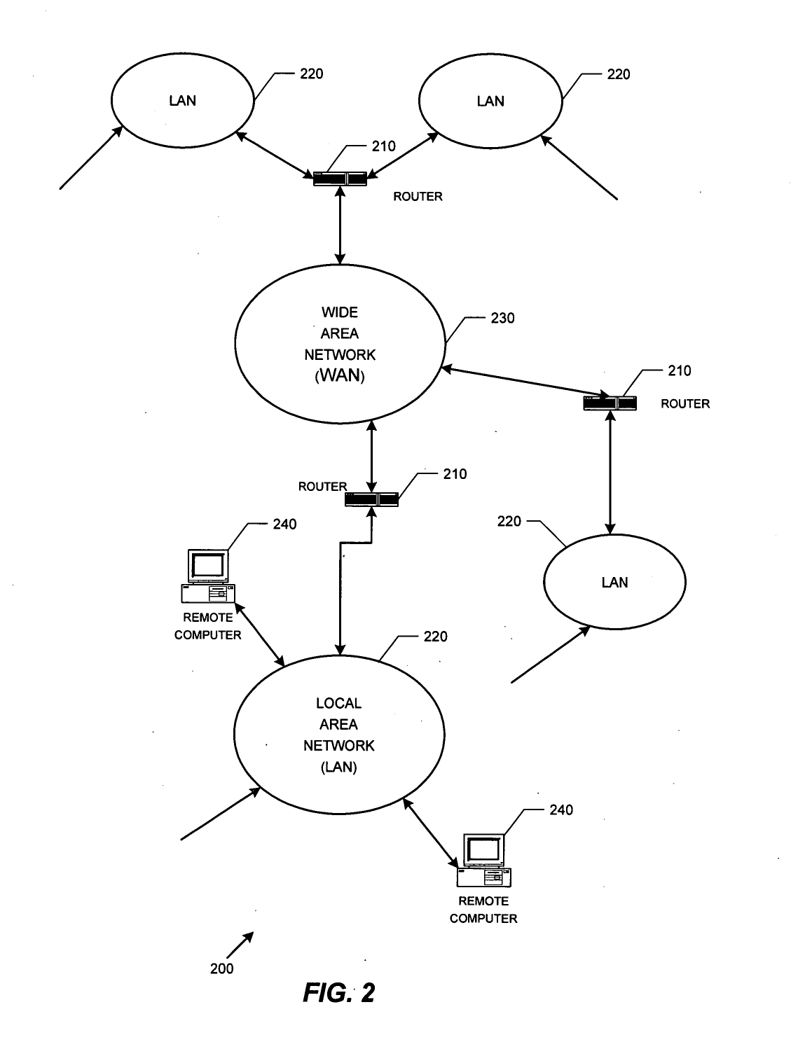

Typically, WAN/LAN 200 transmits information between computing devices as described in more detail in conjunction with FIG. 2. One example of a WAN is the Internet, which connects millions of computers over a host of gateways, routers, switches, hubs, and the like. An example of a LAN is a network used to connect computers in a single office. A WAN may be used to connect multiple LANs.

It will be recognized that the distinctions between WANs/LANs, phone networks, and wireless networks are blurring. That is, each of these types of networks may include one or more portions that would logically belong to one or more other types of networks. For example, WAN/LAN 200 may include some analog or digital phone lines to transmit information between computing devices. Phone network 120 may include wireless components and packet-based components, such as voice over IP. Wireless network 105 may include wired components and/or packet-based components. Network means a WAN/LAN, phone network, wireless network, or any combination thereof.

FIG. 2 shows a plurality of local area networks (“LANs”) 220 and wide area network (“WAN”) 230 interconnected by routers 210. Routers 210 are intermediary devices on a communications network that expedite packet delivery. On a single network linking many computers through a mesh of possible connections, a router receives transmitted packets and forwards them to their correct destinations over available routes. On an interconnected set of LANs—including those based on differing architectures and protocols—, a router acts as a link between LANs, enabling packets to be sent from one to another. A router may be implemented using special purpose hardware, a computing device executing appropriate software, such as computing device 300 as described in conjunction with FIG. 3, or through any combination of the above.

Communication links within LANs typically include twisted pair, fiber optics, or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links, or other communications links known to those skilled in the art. Furthermore, computers, such as remote computer 240, and other related electronic devices can be remotely connected to either LANs 220 or WAN 230 via a modem and temporary telephone link. The number of WANs, LANs, and routers in FIG. 2 may be increased or decreased arbitrarily without departing from the spirit or scope of this invention.

As such, it will be appreciated that the Internet itself may be formed from a vast number of such interconnected networks, computers, and routers. Generally, the term “Internet” refers to the worldwide collection of networks, gateways, routers, and computers that use the Transmission Control Protocol/Internet Protocol (“TCP/IP”) suite of protocols to communicate with one another. At the heart of the Internet is a backbone of high-speed data communication lines between major nodes or host computers, including thousands of commercial, government, educational, and other computer systems, that route data and packets. An embodiment of the invention may be practiced over the Internet without departing from the spirit or scope of the invention.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media.

The Internet has recently seen explosive growth by virtue of its ability to link computers located throughout the world. As the Internet has grown, so has the WWW. Generally, the WWW is the total set of interlinked hypertext documents residing on HTTP (hypertext transport protocol) servers around the world. Documents on the WWW, called pages or Web pages, are typically written in HTML (Hypertext Markup Language) or some other markup language, identified by URLs (Uniform Resource Locators) that specify the particular machine and pathname by which a file can be accessed, and transmitted from server to end user using HTTP. Codes, called tags, embedded in an HTML document associate particular words and images in the document with URLs so that a user can access another file, which may literally be halfway around the world, at the press of a key or the click of a mouse. These files may contain text, (in a variety of fonts and styles), graphics images, movie files, media clips, and sounds as well as Java applets, ActiveX controls, or other embedded software programs that execute when the user activates them. A user visiting a Web page also may be able to download files from an FTP site and send packets to other users via email by using links on the Web page.

A computing device that may provide a WWW site is described in more detail in conjunction with FIG. 3. When used to provide a WWW site, such a computing device is typically referred to as a WWW server. A WWW server is a computing device connected to the Internet having storage facilities for storing hypertext documents for a WWW site and running administrative software for handling requests for the stored hypertext documents. A hypertext document normally includes a number of hyperlinks, i.e., highlighted portions of text which link the document to another hypertext document possibly stored at a WWW site elsewhere on the Internet. Each hyperlink is associated with a URL that provides the location of the linked document on a server connected to the Internet and describes the document. Thus, whenever a hypertext document is retrieved from any WWW server, the document is considered to be retrieved from the WWW. As is known to those skilled in the art, a WWW server may also include facilities for storing and transmitting application programs, such as application programs written in the JAVA programming language from Sun Microsystems, for execution on a remote computer. Likewise, a WWW server may also include facilities for executing scripts and other application programs on the WWW server itself.

A user may retrieve hypertext documents from the WWW via a WWW browser application program located on a wired or wireless device. A WWW browser, such as Netscape's NAVIGATOR® or Microsoft's INTERNET EXPLORER®, is a software application program for providing a graphical user interface to the WWW. Upon request from the user via the WWW browser, the WWW browser accesses and retrieves the desired hypertext document from the appropriate WWW server using the URL for the document and HTTP. HTTP is a higher-level protocol than TCP/IP and is designed specifically for the requirements of the WWW. HTTP is used to carry requests from a browser to a Web server and to transport pages from Web servers back to the requesting browser or client. The WWW browser may also retrieve application programs from the WWW server, such as JAVA applets, for execution on a client computer.

FIG. 3 shows a computing device. Such a device may be used, for example, as a server, workstation, network appliance, router, bridge, firewall, exploit detector, gateway, and/or as a traffic management device. When used to provide a WWW site, computing device 300 transmits WWW pages to the WWW browser application program executing on requesting devices to carry out this process. For instance, computing device 300 may transmit pages and forms for receiving information about a user, such as address, telephone number, billing information, credit card number, etc. Moreover, computing device 300 may transmit WWW pages to a requesting device that allows a consumer to participate in a WWW site. The transactions may take place over the Internet, WAN/LAN 100, or some other communications network known to those skilled in the art.

It will be appreciated that computing device 300 may include many more components than those shown in FIG. 3. However, the components shown are sufficient to disclose an illustrative environment for practicing the present invention. As shown in FIG. 3, computing device 300 may be connected to WAN/LAN 200, or other communications network, via network interface unit 310. Network interface unit 310 includes the necessary circuitry for connecting computing device 300 to WAN/LAN 200, and is constructed for use with various communication protocols including the TCP/IP protocol. Typically, network interface unit 310 is a card contained within computing device 300.

Computing device 300 also includes processing unit 312, video display adapter 314, and a mass memory, all connected via bus 322. The mass memory generally includes random access memory (“RAM”) 316, read-only memory (“ROM”) 332, and one or more permanent mass storage devices, such as hard disk drive 328, a tape drive (not shown), optical drive 326, such as a CD-ROM/DVD-ROM drive, and/or a floppy disk drive (not shown). The mass memory stores operating system 320 for controlling the operation of computing device 300. It will be appreciated that this component may comprise a general-purpose operating system including, for example, UNIX, LINUX™, or one produced by Microsoft Corporation of Redmond, Wash. Basic input/output system (“BIOS”) 318 is also provided for controlling the low-level operation of computing device 300.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory may also store program code and data for providing a WWW site. More specifically, the mass memory may store applications including special purpose software 330, and other programs 334. Special purpose software 330 may include a WWW server application program that includes computer executable instructions which, when executed by computing device 300, generate WWW browser displays, including performing the logic described above. Computing device 300 may include a JAVA virtual machine, an SMTP handler application for transmitting and receiving email, an HTTP handler application for receiving and handing HTTP requests, JAVA applets for transmission to a WWW browser executing on a client computer, and an HTTPS handler application for handling secure connections. The HTTPS handler application may be used for communication with an external security application to send and receive sensitive information, such as credit card information, in a secure fashion.

Computing device 300 may also comprise input/output interface 324 for communicating with external devices, such as a mouse, keyboard, scanner, or other input devices not shown in FIG. 3. In some embodiments of the invention, computing device does not include user input/output components. For example, computing device 300 may or may not be connected to a monitor. In addition, computing device 300 may or may not have video display adapter 314 or input/output interface 324. For example, computing device 300 may implement a network appliance, such as a router, gateway, traffic management device, etc., that is connected to a network and that does not need to be directly connected to user input/output devices. Such a device may be accessible, for example, over a network.

Computing device 300 may further comprise additional mass storage facilities such as optical drive 326 and hard disk drive 328. Hard disk drive 328 is utilized by computing device 300 to store, among other things, application programs, databases, and program data used by a WWW server application executing on computing device 300. A WWW server application may be stored as special purpose software 330 and/or other programs 334. In addition, customer databases, product databases, image databases, and relational databases may also be stored in mass memory or in RAM 316.

As will be recognized from the discussion below, aspects of the invention may be embodied on routers 210, on computing device 300, on a gateway, on a firewall, on other devices, or on some combination of the above. For example, programming steps protecting against exploits may be contained in special purpose software 330 and/or other programs 334.

Exemplary Configuration of System to Protect from Exploits

FIG. 4 illustrates an exemplary environment in which a system for providing exploit protection for a network operates, according to one embodiment of the invention. The system includes outside network 405, firewall 500, network appliance 415, workstation 420, file server 425, mail server 430, mobile device 435 application server 440, telephony device 445, and network 450. Network 450 couples firewall 500 to network appliance 415, workstation 420, file server 425, mail server 430, mobile device 435, application server 440, and telephony device 445. Firewall 500 couples network 450 to outside network 405.

Network appliance 415, workstation 420, file server 425, mail server 430, mobile device 435, application server 440, and telephony device 445 are devices capable of connecting with network 450. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. Some devices may be capable of connecting to network 450 using a wired or wireless communication medium such as a PDA, POCKET PC, wearable computer, or other device mentioned above that is equipped to use a wired and/or wireless communications medium. An exemplary device that may implement any of the devices above is computing device 300 of FIG. 3 configured with the appropriate hardware and/or software.

Network appliance 415 may be, for example, a router, switch, or some other network device. Workstation 420 may be a computer used by a user to access other computers and resource reachable through network 450, including outside network 405. File server 425 may, for example, provide access to mass storage devices. Mail server 430 may store and provide access to email messages. Mobile device 435 may be a cell phone, PDA, portable computer, or some other device used by a user to access resources reachable through network 450. Application server 440 may store and provide access to applications, such as database applications, accounting applications, etc. Telephony device 445 may provide means for transmitting voice, fax, and other messages over network 450. Each of these devices may represent many other devices capable of connecting with network 450 without departing from the spirit or scope of the invention.

Outside network 405 and Network 450 are networks as previously defined in this document. Outside network may be, for example, the Internet or some other WAN/LAN.

Firewall 500 provides a pathway for messages from outside network 405 to reach network 450. Firewall 500 may or may not provide the only pathway for such messages. Furthermore, there may be other computing devices (not shown) in the pathway between outside network 405 and network 450 without departing from the spirit or scope of the invention. Firewall may be included on a gateway, router, switch, or other computing device or simply accessible to such devices.

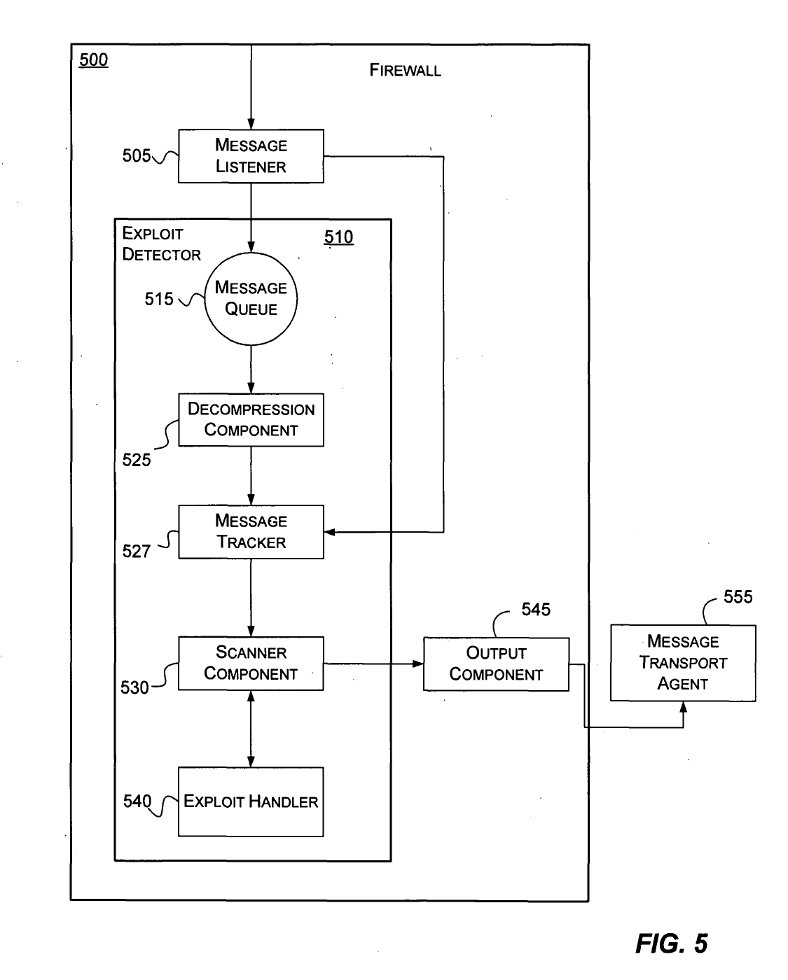

Firewall 500 may provides exploit protection for devices coupled to network 450 by including and/or accessing an exploit detector (not shown) as described in more detail in conjunction with FIG. 5. Firewall 500 may be configured to send certain types of messages through an exploit detector. For example, firewall 500 may be configured to perform normal processing on non-email data while passing all email messages through an exploit detector.

Exemplary Exploit Detector

FIG. 5 illustrates components of a firewall operable to provide exploit protection, according to one embodiment of the invention. The components of the firewall 500 include message listener 505, exploit detector 510, and output component 545. Exploit detector 510 includes message queue 515, decompression component 525, message tracker 527, scanner component 530, and exploit handler 540. Also shown is message transport agent 555.

Firewall 500 may receive many types of messages sent between devices coupled to network 450 and outside network 405 of FIG. 4. Some messages may relate to WWW traffic or data transferred between two computers engaged in a communication while other messages may relate to email. Message listener 505 listens for a message and, upon receipt of an appropriate message, such as an email or file, sends the message to exploit detector 510 to scan for exploits.

When processing email messages, exploit detector 510 provides exploit protection, in part, by scanning and verifying the fields of an email message. An email message typically includes a header (which may include certain fields), a body (which typically contains the text of an email), and one or more optional attachments. Exploit detector 510 may examine the lengths of the fields of an email message to determine whether they are longer than they should be. Being “longer than they should be” may be defined by standards, mail server specifications, or selected by a firewall administrator. If an email message includes any fields that are longer than they should be, the message may be sent to exploit handler 540 as described in more detail below.

Exploit detector 510 may utilize exploit protection software from many vendors. For example, a client may execute on exploit detector 510 that connects to a virus protection update server. Periodically, the client may poll a server associated with each vendor and look for a flag to see if an exploit protection update is available. If there is an update available, the client may automatically retrieve the update and check it for authenticity. For example, the update may include a digital signature that incorporates a hash of the files sent. The digital signature may be verified to make sure that the files came from a trusted sender, and the hash may be used to make sure that none of the files have been modified in transit. Another process may unpack the update, stop the execution of exploit detector 510, install the update, and restart exploit detector 510.

Exploit detector 510 may be configured to poll for customized exploit protection updates created by, for example, an information technology team. This process may execute in a manner similar to the polling for vendor updates described above.

In addition to, or in lieu of polling, updates may be pushed to exploit detector 510. That is, a client may execute on exploit detector 510 that listens for updates from exploit protection update servers. To update the exploit protection executing on firewall 410, such servers may open a connection with the client and send exploit protection updates. A server sending an update may be required to authenticate itself. Furthermore, the client may check the update sent to make sure that files have not changed in transit by using a hash as described above.

The components of exploit detector 510 will now be explained. Upon receipt of a message to scan for exploits, exploit detector 510 stores the message in message queue 515. Decompression component 525 determines whether a message is compressed. If the message is not compressed, the bits that make up the message are sent serially to message tracker 527. If the message is compressed, decompression component 525 may decompress the message one or more times before sending it to message tracker 527. Decompressions may be done in a nested fashion if a message has been compressed multiple times. For example, a set of files included in a message may first be zipped and then tarred using the UNIX “tar” command. After untarring a file, decompression component 525 may determine that the untarred file was previously compressed by zipping software such as WinZip. To obtain the unzipped file(s), decompression component 525 may then unzip the untarred file. There may be more than two levels of compression that decompression component 525 decompresses to obtain decompressed file(s).

Message tracker 527 receives decompressed messages and messages that were not compressed from decompression component 525. Message tracker 527 is directed to optimizing the path of a message through exploit detector 510 by minimizing scans of a previously scanned message and or its attachments. Message tracker 527 achieves this by determining whether a message or attachment has been scanned previously for exploits. Messages and attachments that message tracker 527 determine have not been scanned may be forwarded to scanner component 527. If message tracker 527 determines a message or attachment has been scanned previously, message tracker 527 is configured to forward the message or attachment to other message protection components for further processing. Message tracker 527 is also configured to enable scanning of a previously scanned message or attachment, if the scanner component 530 or its associated components have been updated, revised, modified, or the like.

Message tracker 527 may determine whether an object (a message, attachment, and the like) has been scanned previously for exploits by implementing a two-phase hash value matching technique. In particular, message tracker 527 may associate a ROHV and a SSHV with an object that has been previously scanned. Message tracker 527 may cache ROHVs and SSHVs of previously scanned objects to determine whether a particular object should be scanned or to be immediately processed. The ROHV is typically determined based on a simple technique that only requires a simple computation. For example, the ROHV of an object may be determined from a hash value (such as an XOR hash) of the first few bytes or any portion of a file. The ROHV may also be determined using simple parameters like the object size and the like. The ROHV enables message tracker 527 to roughly distinguish one object from other objects. If an object matches one of the ROHVs cached by message tracker 527, that object would warrant further inspection using SSHVs.

An SSHV is typically determined based on a sophisticated hash function, such as Message Digest-5 (MD-5), Secure Hash Algorithm (SHA), Secure Hash Standard, and the like. The values may also be determined based on a public key certificate, a digital signature, a checksum function, or similar algorithmic mechanism that provides a value that distinguishes one object from other objects. If an object matches one of the SSHVs cached by message tracker 527, that object may be processed without being scanned by scanner component 530.

The two-phase hash value matching technique implemented by message tracker 527 is based on an observation that when both ROHVs and SSHVs of two objects match, the confidence that the two objects are actually identical is very high. Also, when the ROHVs of two objects do not match, the two objects are different.

Message tracker 527 is configured to store the ROHVs and SSHVs with sufficient information to associate the object with the values. The values may be stored in a list, database, file, table, or the like. Moreover, the values may be stored locally or in a distributed manner. Message tracker 527 may also be configured to cache the ROHVs and SSHVs in memory to increase system performance.

Scanner component 530 receives messages and attachments from message tracker 527. Scanner component 530 includes software that scans the message for exploits. Scanner component 530 may scan messages using exploit protection software from many vendors. For example, scanner component 530 may pass a message through software from virus protection software vendors such as Trend Micro, Norton, MacAfee, Network Associates, Inc., Kaspersky Lab, Sophos, and the like. In addition, scanner component 530 may apply proprietary or user-defined algorithms to the message to scan for exploits. For example, a user-defined algorithm testing for buffer overflows may be used to detect exploits.

Scanner component 530 may also include an internal mechanism that creates digital signatures for messages and content that an administrator wants to prevent from being distributed outside a network. For example, referring to FIG. 4, a user on one of the computing devices may create a message or try to forward a message that is confidential to outside network 405. Scanner component 530 may examine each message it receives (including outbound messages) for such digital signatures. When a digital signature is found that indicates that the message should not be forwarded, scanner component 530 may forward the message to quarantine component together with information as to who sent the message, the time the message was sent, and other data related to the message.

When a message is determined to have an exploit, the message may be sent to an exploit handler 540. Exploit handler 540 may store messages that contain exploits for further examination by, for example, a network administrator. In addition, exploit handler 540 may remove the exploits from messages.

When scanner component 530 does not find an exploit in a message, the message may be forwarded to output component 545. Output component 545 forwards a message towards its recipient. Output component 545 may be hardware and/or software operative to forward messages over a network. For example, output component 545 may include a network interface such as network interface unit 310.

A firewall may perform other tasks besides passing messages to an exploit detector. For example, a firewall may block messages to or from certain addresses. Message transport agent 555 is a computing device that receives email. Email receiving devices include mail servers. Examples of mail servers include Microsoft Exchange, Q Mail, Lotus Notes, etc. Referring to FIG. 4, firewall 500 may forward a message to mail server 430.

Illustrative Method of Scanning for Exploits

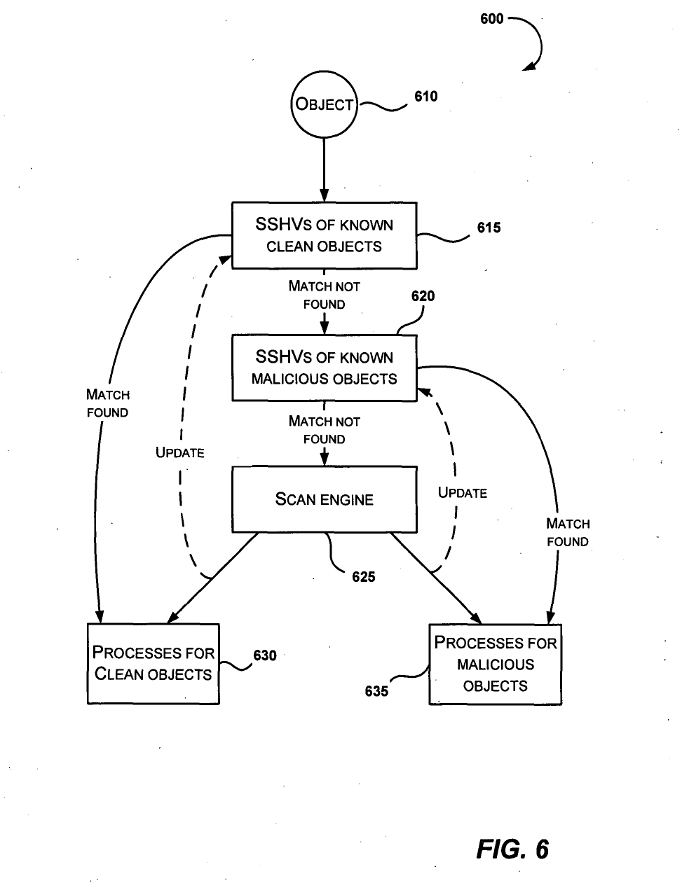

FIG. 6 is a graphical representation of an exemplary process for inspecting an object using the object's SSHV, according to one embodiment of the invention. Object 610 is to be inspected for exploits. As shown in the figure, process 600 includes both a white-list check and a blacklist check. The checks are implemented to determine whether object 610 has been previously scanned. Process 600 may be implemented with both checks or just one of the checks.

The white-list check is represented by block 615. The white-list check uses the SSHVs of objects that have been previously scanned and determined to be clean (i.e. without any exploit). The SSHV of object 610 is matched against the SSHVs in block 620. If a match is found, object 610 is determined to be clean and is sent to block 630 where object 610 is to be processed as a clean object. For example, object 610 may be forwarded to a destination.

Returning to block 615, if a match is not found, process 600 continues at block 620 where a blacklist check is performed. The blacklist check uses the SSHVs of objects that have been previously scanned and determined to be malicious (i.e. having an exploit). The SSHV of object 610 is matched against the SSHVs in block 615. If a match is found, object 610 is determined to be malicious and is sent to block 635 where object 610 is to be processed as a malicious object. For example, object 610 may be quarantined, processed to remove an exploit, and the like.

Returning to block 625, if a match is not found, object 610 is determined to be an unscanned object (i.e. has not been previously scanned). In this case, object 610 is passed to a scan engine, as represented by block 625. The scan engine scans object 610 to determine whether the object is clean or malicious. If the object is clean, the SSHV of the object is calculated and recorded in the white-list of block 615. If the object is malicious, the SSHV of the object is calculated and recorded in the blacklist of block 620.

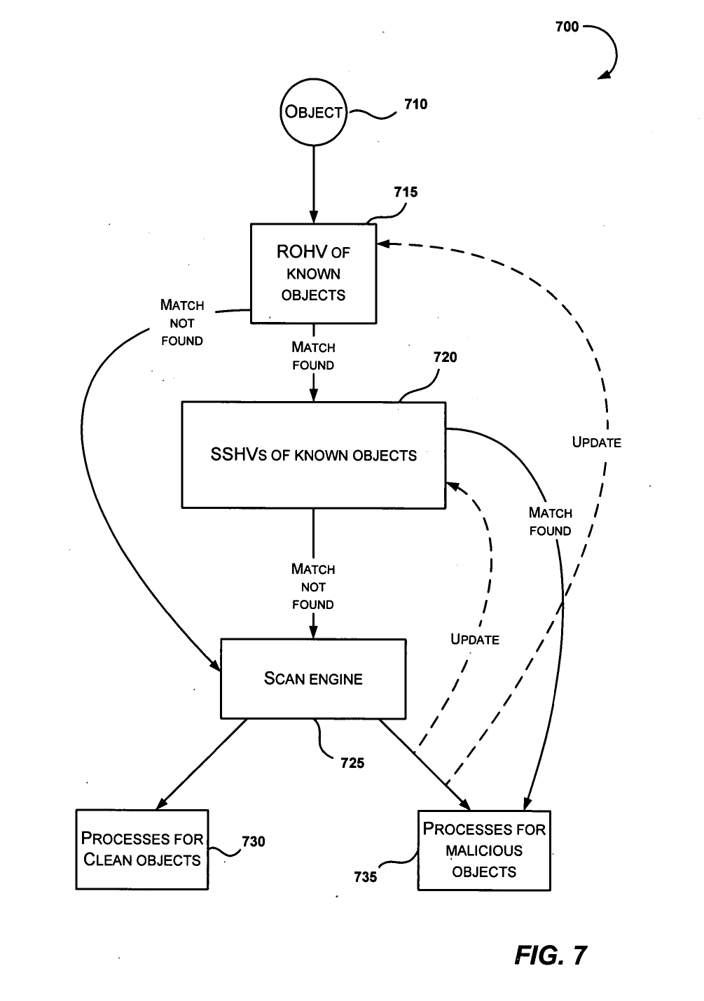

FIG. 7 is a graphical representation of an exemplary process for inspecting an object using a two-phase hash value matching technique, according to one embodiment of the invention. Object 710 is to be inspected for exploits. Process 700 may logically include a ROHV phase and a SSHV phase as described above in detail in conjunction with FIG. 6. The ROHV phase is implemented to avoid performing computations associated with the SSHV phase where possible. In practice, the ROHV phase and the SSHV phase may be integrated for implementation reasons.

The ROHV phase is represented by block 715. The ROHV phase uses the ROHVs of objects that have been previously scanned. The ROHV of object 710 is matched against the ROHVs in block 715. If a match is not found, object 710 is determined to be an unscanned object and is sent to the scan engine 725 to be scanned.

Returning to block 715, if a match is found, object 710 is determined to have a high possibility that it has been previously scanned and is passed to the SSHV phase as represented by block 720 for further testing. At block 720, the SSHV of object 710 is computed and is matched against the SSHVs of known exploits in block 720. If a match is found, object 710 is determined to have been previously scanned and is sent to block 735, where object 710 is to be processed as a malicious object.

Returning to block 720, if a match is not found, object 710 is determined to be an unscanned object. In this case, object 710 is passed to a scan engine, as represented by block 725. The scan engine scans object 710 to determine whether the object is clean or malicious. If the object is malicious, the list in the ROHV phase 715 is updated with the ROHV of the object 710, and the list in the SSHV phase 720 is updated with the SSHV of the object 710.

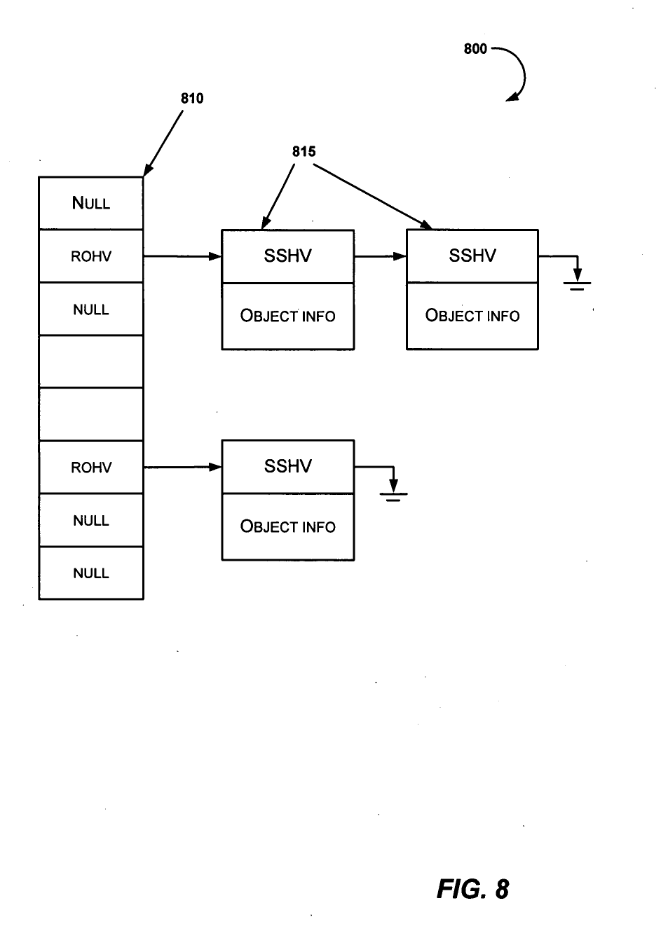

FIG. 8 is a graphical representation of a data structure that implements a two-phase hash value matching technique, according to one embodiment of the invention. The data structure 800 includes first indexing data field 810 with indexing entries associated with ROHVs. Each of the indexing entries with an ROHV may be associated with a second data field 815 that contains one or more SSHV entries. Each of the SSHV entries is associated with a particular object and may include information about the object.

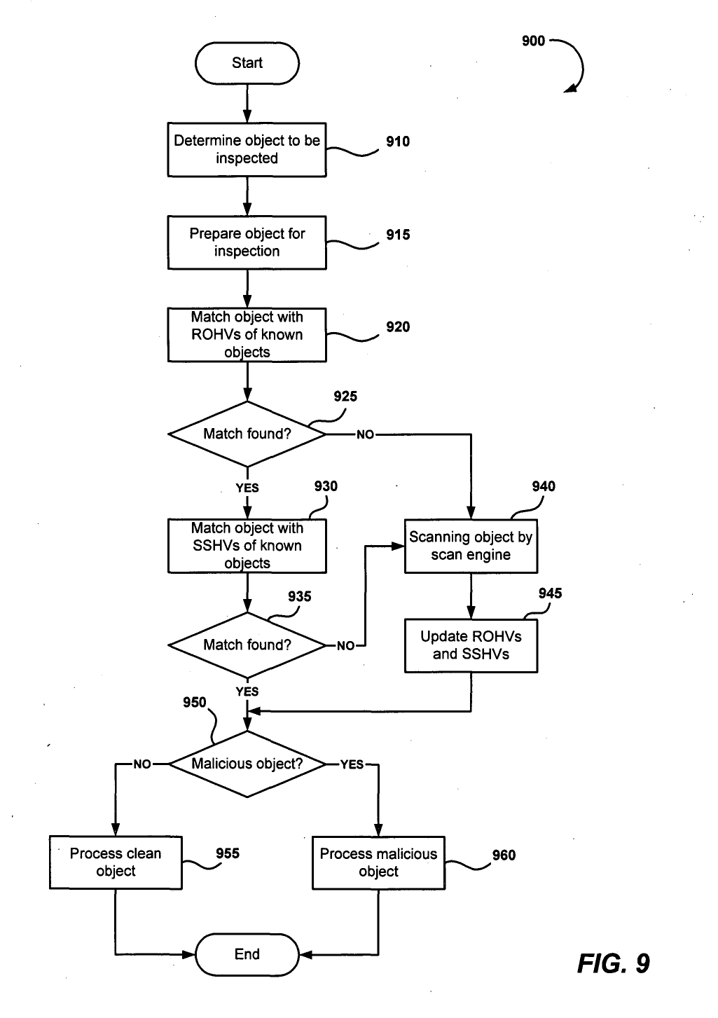

FIG. 9 illustrates a flow chart for detecting exploits, according to one embodiment of the invention. Moving from a start block, process 900 goes to block 910 where an object to be inspected is determined. At block 915, the process prepares the object for inspection. For example, if the object is a message, the process may have to deal with the encapsulation in the message. The process may also have to strip out attachments from the message so that each object may be inspected separate. If the message and the attachments were compressed, the process may have to decompress them. At block 920, the ROHV of the object is determined and is matched against ROHVs of previously scanned objects.

At decision block 925, a determination is made whether the ROHV of the object being inspected matches at least one of the ROHVs of previously scanned object. If there is a match, process 900 moves to block 930 where the SSHV of the object is determined and is matched against SSHVs of previously scanned objects.

At decision block 935, a determination is made whether the SSHV of the object matches at least one of the SSHVs of previously scanned objects. If a match is not found, the object is an unscanned object. This can occur because the ROHV matching in 920 can only roughly determine whether the object is identical to any of the previously scanned object. If no match is found, process goes to block 940. If a match is found, the object can be immediately processed without being scanned by a scan engine. In this case, process 900 goes to decision block 950.

Returning to decision block 925, if the ROHV of the object does not match any of the ROHVs of previously scanned object, the object is an unscanned object and process 900 goes to block 940.

At block 940, the object is scanned by a scan engine. If an exploit is found, process 900 moves to block 945 where the ROHV and the SSHV of the object are determined and are added to the ROHVs and the SSHVs of previously scanned objects. In particular, the ROHV and the SSHV are added to the blacklists at block 920 and block 930. If an exploit is not found in the object and if white-lists were used, the SSHV of object are added to the white-lists. Process 900 continues at decision block 950.

At decision block 950, a determination is made whether the object is malicious. If the object is malicious, the object is processed as a malicious object at block 960. If the object is not malicious, the object is processed as a clean object at block 955. Then, the process ends. The process outlined above may be repeated for each object received.

The various embodiments of the invention may be implemented as a sequence of computer implemented steps or program modules running on a computing system and/or as interconnected machine logic circuits or circuit modules within the computing system. The implementation is a matter of choice dependent on the performance requirements of the computing system implementing the invention. In light of this disclosure, it will be recognized by one skilled in the art that the functions and operation of the various embodiments disclosed may be implemented in software, in firmware, in special purpose digital logic, or any combination thereof without deviating from the spirit or scope of the present invention.

The above specification, examples and data provide a complete description of the manufacture and use of the composition of the invention. Since many embodiments of the invention can be made without departing from the spirit and scope of the invention, the invention resides in the claims hereinafter appended.

1. A method for filtering out exploits passing through a device, comprising:
receiving an object directed to the device;
determining a first value associated with the object;
determining a second set of values associated with objects that have previously been scanned;
if the first value matches at least one of the values in the second set,
determining a third value associated with the object;
determining a fourth set of values associated with the objects that have previously been scanned; and
if the third value matches at least one of the values in the fourth set, immediately processing the object.

2. The method of claim 1, wherein the object includes at least one of a message, an attachment to a message, an email, a computer-executable file, and a data file.

3. The method of claim 1, wherein the at least one of the first value and the third value further comprises at least one of a hash value, an algorithmic function, a checksum, a public key certificate, and a digital signature.

4. The method of claim 1, wherein the first value includes a rough outline hash value (ROHV).

5. The method of claim 4, wherein the third value includes a sophisticated signature hash value (SSHV) and wherein the ROHV requires less time to compute than the SSHV.

6. The method of claim 1, wherein immediately processing the object further comprises processing the object without scanning the object.

7. The method of claim 6, wherein immediately processing the object further comprises removing an exploit from the object.

8. The method of claim 6, wherein immediately processing the object further comprises forwarding the object to a destination.

9. The method of claim 1, further comprising if the first value does not match any of the values in the second set,
scanning the object for an exploit; and
updating the second set of values to include the first value.

10. The method of claim 1, further comprising if the third value does not match any of the values in the fourth set,
scanning the object for an exploit; and
updating the fourth set of values to include the third value.

11. The method of claim 1, wherein the method is operable on at least one of a firewall, a router, a switch, a server, and a dedicated platform.

12. A computer-readable medium encoded with a data-structure, comprising:
a first indexing data field having indexing entries, each indexing entry including a first value; and
a second data field including object-related entries, each object-related entry having a second value and being indexed to an indexing entry in the first indexing data field, each object-related entry being uniquely associated with an object that has been previously scanned.

13. The computer-readable medium of claim 12, wherein at least one of the first value and the second value further comprises at least one of a hash value, an algorithmic function, checksum, public key certificate, and a digital signature.

14. The computer-readable medium of claim 12, wherein the first value is a ROHV.

15. The computer-readable medium of claim 12, wherein the second value is a SSHV.

16. The computer-readable medium of claim 12, wherein at least one object-related entry in the second data field includes information about the associated object.

17. A system for protecting a device against an exploit, comprising:
a message tracker that is configured to determine whether an object has been previously scanned using a two-phase hash value technique; and
a scanner component that is coupled to the message tracker and that is configured to receive an unscanned object and to determine whether the unscanned object includes an exploit.

18. The system of claim 17, wherein the object includes at least one of a message, an attachment to a message, an email, a computer-executable file, and a data file.

19. The system of claim 17, wherein the two-phase hash value technique comprises:
determining a first value associated with the object;
determining a second set of values associated with objects that have previously been scanned; and
if the first value does not match at least one of the values in the second set, determining that the object has not been previously scanned.

20. The system of claim 19, wherein the first value further comprises at least one of a hash value, an algorithmic function, checksum, public key certificate, and a digital signature.

21. The system of claim 19, wherein the first value further comprises a ROHV.

22. The system of claim 19, wherein the two-phase hash value technique further comprises:
if the first value matches at least one of the values in the second set,
determining a third value associated with the object;
determining a fourth set of values associated with the objects that have previously been scanned;
if the third value does not match at least one of the values in the fourth set, determining that the object has not been previously scanned.

23. The system of claim 22, wherein the third value further comprises at least one of a hash value, an algorithmic function, checksum, public key certificate, and a digital signature.

24. The system of claim 22, wherein the third value further comprises a SSHV.

25. The system of claim 22, wherein the two-phase hash value technique further comprises:
if the third value approximately matches at least one of the values in the fourth set, determining that the object has been previously scanned.

26. The system of claim 17, wherein the system is operable on at least one of a firewall, a router, a switch, a server, and a dedicated platform.

27. An apparatus for protecting a device against an exploit, comprising:
means for receiving an object directed to the device;
means for determining whether the object has been previously scanned using a two-phase hash value technique; and
means for immediately processing the object if the object has been previously scanned.

28. The apparatus of claim 27, further comprising means for scanning the object if the object has not been previously scanned.

29. The apparatus of claim 27, further comprising:
means for maintaining a list of previously scanned objects for the two-phase hash value technique; and
means for updating the list.
